(19) United States
(12) Patent Application Publication
(10) Pub. No.: US 2021/0300229 A1
(43) Pub. Date: Sep. 30, 2021

(54) SYSTEM, VEHICLE, AND METHOD

(71) Applicant: TOYOTA JIDOSHA KABUSHIKI KAISHA, Toyota-shi (JP)

(72) Inventors: Yuki NAKANO, Nisshin-shi (JP); Masato URA, Nisshin-shi (JP); Koji TAKAO, Toyota-shi (JP); Hideyuki SAKURAI, Toyota-shi (JP); Keisuke HOTTA, Miyoshi-shi (JP); Rieko MASUTANI, Toyota-shi (JP); Atsushi HANAWA, Miyoshi-shi (JP); Masanobu OHMI, Kasugai-shi (JP); Takashi HAYASHI, Nagoya-shi (JP); Atsushi NABATA, Nagakute-shi (JP); Tetsuro SAKAGUCHI, Toyota-shi (JP)

(73) Assignee: TOYOTA JIDOSHA KABUSHIKI KAISHA, Toyota-shi (JP)

(21) Appl. No.: 17/206,958

(22) Filed: Mar. 19, 2021

(30) Foreign Application Priority Data
Mar. 24, 2020 (JP) 2020-052518

(51) Int. Cl. B60P 3/00; A47G 29/12; A47G 29/122

(52) U.S. Cl. CPC B60P 3/007; A47G 29/122; A47G 29/1209

(57) ABSTRACT

The present disclosure is directed to a system including a vehicle including a collection and placement mechanism configured to collect and place a mailbox, a plurality of mailboxes that are capable of being transported, collected, and placed by the vehicle, and a controller. The controller causes the vehicle to execute being loaded with a first mailbox containing no posted matter, moving to a placement site of a second mailbox containing a posted matter in a state of being loaded with the first mailbox, and collecting the second mailbox and newly placing the first mailbox, at the placement site of the second mailbox by the collection and placement mechanism, to replace the mailboxes.

### CROSS REFERENCE TO THE RELATED APPLICATION

This application claims the benefit of Japanese Patent Application No. 2020-052518, filed on Mar. 24, 2020, which is hereby incorporated by reference herein in its entirety.

### BACKGROUND

### Technical Field

The present disclosure relates to a system, a vehicle, and a method.

### Description of the Related Art

Mailbox cars as mobile post offices with mailboxes mounted thereon are in service (see, for example, Non-Patent Document 1).

### CITATION LIST

### Non-Patent Document

[Non-Patent Document 1] Toshiya, Koketsu, “Retorona akai posutoka zenkoku unko kaishi, ehagaki bae suru hukei wo meguru” (Red retro-looking mailbox cars go into service on nationwide scale and visit postcard-worthy spots) [online], Jul. 20, 2019, Response, [retrieved on Jul. 23, 2019], <URL: https://response.jp/article/2019/07/20/324618.html>

### SUMMARY

Mailboxes are generally installed at predetermined positions, and a mail person collects posted matters in each mailbox at a predetermined time.

One or more aspects of the disclosure are directed to provide a system, a vehicle, and a method capable of reducing the human load associated with collection of posted matters in a mailbox.

One aspect of the present disclosure may be directed to

a system including

a vehicle including a collection and placement mechanism configured to collect and place a mailbox,

a plurality of mailboxes that is capable of being transported, collected, and placed by the vehicle, and

a controller comprising at least one processor configured to cause the vehicle to execute

being loaded with a first mailbox containing no posted matter,

moving to a placement site of a second mailbox containing a posted matter in a state of being loaded with the first mailbox, and

collecting the second mailbox and newly placing the first mailbox, at the placement site of the second mailbox, by the collection and placement mechanism, in order to replace the mailboxes.

Another aspect of the present disclosure may be directed to

a vehicle including

a running mechanism including a plurality of wheels,

a collection and placement mechanism configured to collect and place a mailbox, and

a controller comprising at least one processor configured to execute

causing the collection and placement mechanism to load a first mailbox containing no posted matter,

causing the running mechanism to move to a placement site of a second mailbox containing a posted matter in a state of being loaded with the first mailbox, and

causing the collection and placement mechanism to collect the second mailbox and newly place the first mailbox, at the placement site of the second mailbox.

One aspect of the present disclosure may be directed to

a method for causing a vehicle including a collection and placement mechanism configured to collect and place a mailbox to execute

being loaded with a first mailbox containing no posted matter;

moving to a placement site of a second mailbox containing a posted matter in a state of being loaded with the first mailbox, and

collecting the second mailbox and newly placing the first mailbox, at the placement site of the second mailbox, by the collection and placement mechanism, in order to replace the mailboxes.

The system, the vehicle, and the method according to the present disclosure allow reduction in the human load associated with collection of posted matters in a mailbox.

### BRIEF DESCRIPTION OF THE DRAWINGS

FIG. 1 is a diagram illustrating an example of a system configuration of a mailbox collection system according to a first embodiment;

FIG. 2 is a diagram illustrating an example of a hardware configuration of a vehicle;

FIG. 3 is a diagram illustrating an example of a method for mailbox collection and placement by the vehicle;

FIG. 4 is a diagram illustrating an example of the method for mailbox collection and placement by the vehicle;

FIG. 5 is a diagram illustrating an example of the method for mailbox collection and placement by the vehicle;

FIG. 6 is a diagram illustrating an example of a hardware configuration of a center server;

FIG. 7 is a diagram illustrating examples of functional configurations of the center server and the vehicle according to the first embodiment;

FIG. 8 is an example of a mailbox placement information management table;

FIG. 9 is an example of a mailbox information management table;

FIG. 10 is an example of a process, by the center server according to the first embodiment, of controlling mailbox collection and placement by the vehicle;

FIG. 11 is an example of a flowchart of an operation process associated with mailbox collection and placement by the vehicle;

FIG. 12 is an example of a hardware configuration of a mailbox according to a second embodiment;

FIG. 13 is a diagram illustrating examples of functional configurations of a center server, a vehicle, and the mailbox according to the second embodiment;

FIG. 14 is an example of a mailbox placement information management table according to the second embodiment;

FIG. 15 is an example of a flowchart of a process by the mailbox;

FIG. 16 is an example of a process, by the center server according to the second embodiment, of controlling mailbox collection and placement by the vehicle; and

FIG. 17 is a diagram illustrating an example of a system configuration of a mailbox collection system according to a third embodiment.

### DESCRIPTION OF THE EMBODIMENTS

One aspect of the present disclosure may be directed to a system including a vehicle including a collection and placement mechanism configured to collect and place a mailbox, a plurality of mailboxes that is capable of being transported, collected, and placed by the vehicle, and a controller. The controller may cause the vehicle to execute being loaded with a first mailbox containing no posted matter, moving to a placement site of a second mailbox containing a posted matter in a state of being loaded with the first mailbox, and collecting the second mailbox and newly placing the first mailbox, at the placement site of the second mailbox, by the collection and placement mechanism, in order to replace the mailboxes. The controller may be, for example, a server or a computer which is mounted on the vehicle.

The collection and placement mechanism of the vehicle may include at least one holder configured to hold a mailbox. The holder may move from inside the vehicle to outside the vehicle while holding the first mailbox and move from outside the vehicle to inside the vehicle while holding the second mailbox to replace the mailboxes. Alternatively, the collection and placement mechanism of the vehicle may include at least one plate, one end of which protrudes outward from the vehicle when the plate slides. The one end of the plate may collect the second mailbox by getting under the second mailbox and being loaded with the second mailbox when the one end of the plate protrudes outward from the vehicle, and sliding into the vehicle, and the one end of the plate may place the first mailbox by protruding outward from the vehicle in a state of being loaded with the first mailbox, and leaving the first mailbox and sliding into the vehicle.

The vehicle may be a vehicle that is capable of autonomous running. The collection and placement mechanism of the vehicle may be provided on a top surface of the vehicle. Alternatively, the collection and placement mechanism of the vehicle may be provided inside the vehicle.

According to the one aspect of the present disclosure, the vehicle performs posted matter collection by replacing a mailbox containing posted matters with a mailbox containing no posted matter and collecting the mailbox containing the posted matters. This allows reduction in the human load associated with posted matter collection.

In the one aspect of the present disclosure, each of the plurality of mailboxes may include a sensor configured to sense posting of a posted matter, and a communicator configured to transmit a request for pickup of a posted matter when posting of the posted matter is sensed. When the request for pickup of the posted matter is received from the second mailbox, the controller may cause the vehicle to execute being loaded with the first mailbox, moving to the placement site of the second mailbox, and replacing the mailboxes. This makes it possible to, when there is a mailbox without a posted matter, omit replacement and collection of the mailbox.

In the one aspect of the present disclosure, the vehicle may further include a posted matter collector configured to collect a posted matter contained in a mailbox. When a plurality of second mailbox is installed at a plurality of placement site, the controller may cause the collection and placement mechanism to reuse one of the second mailboxes, a posted matter of which is collected by the posted matter collector, as a new first mailbox and replace another one of the second mailboxes, from which a posted matter is to be collected next, with the new first mailbox. With this configuration, only one empty mailbox needs to be prepared to collect a plurality of mailboxes, and the efficiency of mailbox usage can be improved.

Embodiments of the present disclosure will be described below with reference to the drawings. Configurations according to the embodiments below are illustrative only, and the present disclosure is not limited to the configurations according to the embodiments.

### First Embodiment

<System Outline>

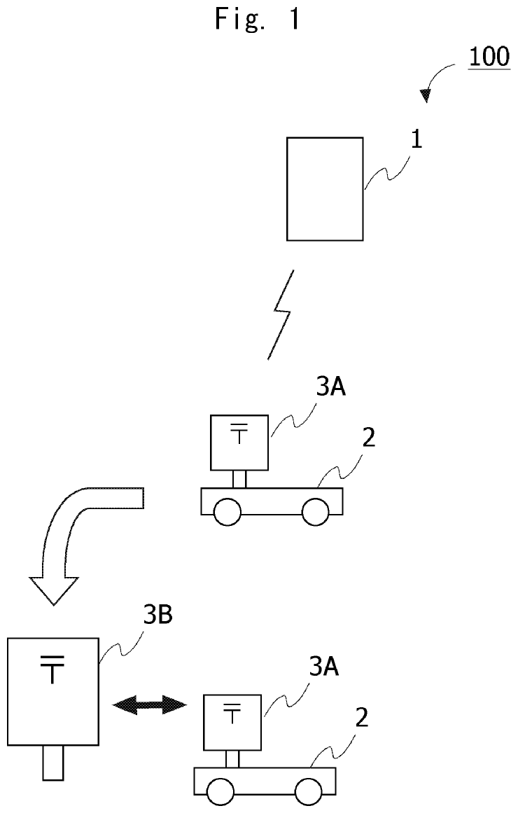

FIG. 1 is a diagram illustrating an example of a system configuration of a mailbox collection system 100 according to a first embodiment. The mailbox collection system 100 is a system for collecting a mailbox which is installed at a predetermined position. The mailbox collection system 100 includes a center server 1, a vehicle 2, and mailboxes 3A and 3B. Note that the mailbox collection system 100 may include a plurality of vehicles 2. For the sake of convenience, one vehicle 2 is illustrated in FIG. 1. The mailbox collection system 100 may include three or more mailboxes. For the sake of convenience, two mailboxes 3A and 3B are illustrated in FIG. 1. The mailbox collection system 100 is an example of a system.

The vehicle 2 is a vehicle without a cabin unit. The vehicle 2 is, for example, a vehicle which is capable of automated-driving running and unattended-driving running. Note that the vehicle 2 is not limited to this and may be a vehicle which includes at least a driver's seat and runs by being driven by a driver.

The mailbox 3A is an empty mailbox which contains no posted matter. The mailbox 3B is a mailbox which is placed at a predetermined position and accepts a posted matter. An estimated time of posted matter pickup is set for a mailbox placement site. Note that one to several posted matter pickups are scheduled per day. The mailboxes 3A and 3B will hereinafter be referred to as mailboxes 3 unless there is a need to make a distinction therebetween.

In the first embodiment, the center server 1 and the vehicle 2 can communicate with each other using, for example, a public telecommunication network, such as the Internet, or a dedicated network. The center server 1 controls travel of the vehicle 2. Concretely, in the first embodiment, the center server 1 gives an instruction for mailbox collection to the vehicle 2 when a remaining time period before an estimated time of pickup for the mailbox 3B becomes less than a predetermined time period. Upon receipt of the mailbox collection instruction from the center server 1, the vehicle 2 is loaded with the empty mailbox 3A and moves to the placement site of the mailbox 3B. When the vehicle 2 arrives at the placement site of the mailbox 3B, the vehicle 2 replaces the mailbox 3B containing posted matters with the empty mailbox 3A by collecting the mailbox 3B and placing the mailbox 3A. The vehicle 2 transports the mailbox 3B to a mailbox collection site.

Collection of posted matters in a mailbox by the autonomous driving vehicle 2 allows reduction in the human load associated with posted matter collection.

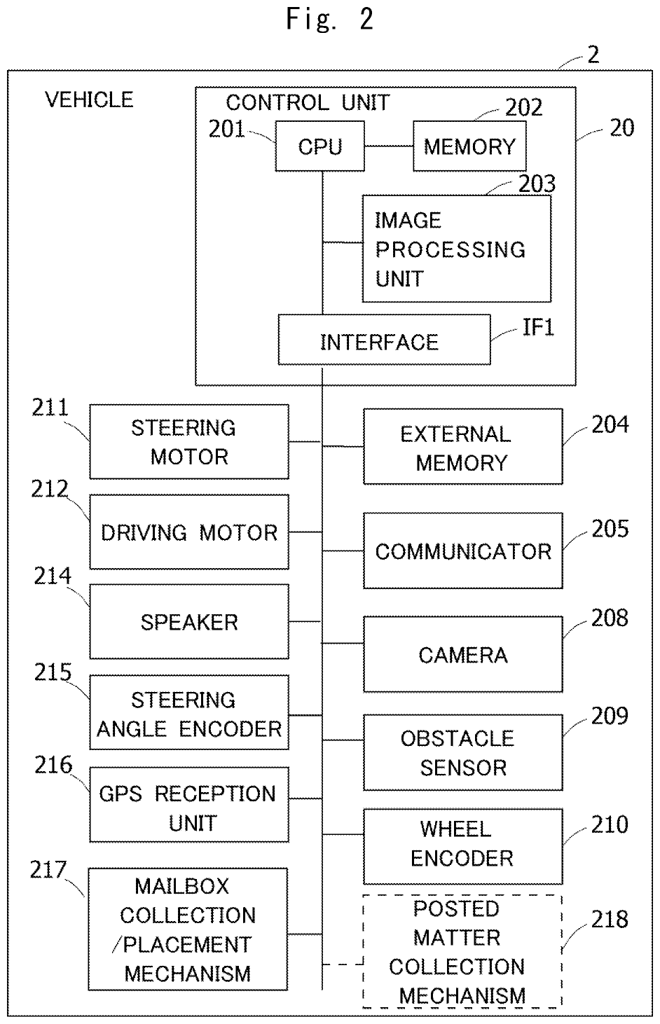

FIG. 2 is a diagram illustrating an example of a hardware configuration of the vehicle 2. In FIG. 2, the vehicle 2 is illustrated as a vehicle capable of autonomous running. Note that pieces of hardware associated with a control system are extracted and illustrated in FIG. 2.

The vehicle 2 includes a control unit 20, an external memory 204, a communicator 205, a camera 208, an obstacle sensor 209, a wheel encoder 210, a steering motor 211, a driving motor 212, a speaker 214, a steering angle encoder 215, a GPS (Global Positioning System) reception unit 216, and a mailbox collection/placement mechanism 217. Note that although a posted matter collection mechanism 218 is also illustrated in FIG. 2, the first embodiment assumes that the vehicle 2 is not provided with the posted matter collection mechanism 218 and that a description thereof will be omitted here.

The control unit 20 is also called an Engine Control Unit (ECU). The control unit 20 includes a CPU 201, a memory 202, an image processing unit 203, and an interface IF1. The external memory 204, the communicator 205, the camera 208, the obstacle sensor 209, the wheel encoder 210, the steering motor 211, the driving motor 212, the speaker 214, the steering angle encoder 215, the GPS reception unit 216, and the mailbox collection/placement mechanism 217 are connected to the interface IF1.

The obstacle sensor 209 is, for example, an ultrasonic sensor, a radar, or the like. The obstacle sensor 209 emits ultrasonic waves, electromagnetic waves, or the like in a target detection direction and detects the presence, the position, the relative velocity, and the like of an obstacle in the target detection direction on the basis of reflected waves. Examples of the obstacle include a pedestrian, a bicycle, a structure, a building, and the like. For example, when the vehicle 2 includes a box-shaped body, the vehicle 2 is provided with a plurality of obstacle sensors 209, and the plurality of obstacle sensors 209 is provided at positions, respectively, near four left and right front and rear corner units of the vehicle 2. The front, rear, left, and right of the vehicle 2 are determined in accordance with, for example, a traveling direction.

The camera 208 is a photograph apparatus which is made up of, e.g., a Charged-Coupled Device (CCD), Metal-Oxide-Semiconductor (MOS), or Complementary Metal-Oxide-Semiconductor (CMOS) image sensor. The camera 208 acquires an image at predetermined time intervals called frame periods and stores the image in a frame buffer in the control unit 20. The vehicle 2 is provided with a plurality of cameras 208, which is installed at left and right front and rear side surfaces of the vehicle 2 toward a vehicle exterior.

The steering motor 211 controls an angle serving as a direction of a line of intersection between a plane of rotation of each wheel and a horizontal plane, i.e., a traveling direction due to rotation of the wheel in accordance with an instruction signal from the control unit 20. The driving motor 212 drives and rotates, for example, four wheels which the vehicle 2 includes in accordance with an instruction signal from the control unit 20. Note that the driving motor 212 may drive either one pair of wheels of the two front and rear pairs of wheels.

The steering angle encoder 215 detects a steering angle which is a running direction for the wheels at predetermined detection time intervals and stores the steering angle in a register of the control unit 20. The steering angle is an angle in the horizontal plane of a rotation axis of each wheel. For example, an initial ray of the angle is set at a direction in which the rotation axis of the wheel is orthogonal to the traveling direction of the vehicle 2. The wheel encoder 210 acquires a rotation angle of each wheel at predetermined detection time intervals and stores the rotation angle in the register of the control unit 20.

The communicator 205 is a communicator for connecting to, for example, a Wi-Fi access point or a cell tower and communicating with various types of servers and the like on a network through the public telecommunication network connected to the Wi-Fi access point or the cell tower. The communicator 205 performs wireless communication using wireless signals and a wireless communication method compliant with a predetermined wireless communication standard.

The GPS reception unit 216 receives time signal waves from a plurality of satellites (Global Positioning Satellites) circling the globe and stores the time signal waves in the register of the control unit 20. The speaker 214 is driven by a DIA converter and an amplifier which are connected to the control unit 20 or a signal processing unit and reproduces audio including sound and voice. For example, the speaker 214 is used to emit a warning beep to surroundings of the vehicle 2.

The CPU 201 of the control unit 20 executes a computer program which is developed in the memory 202 so as to be executable and executes processing as the control unit 20. The memory 202 stores the computer program to be executed by the CPU 201, data to be processed by the CPU 201, and the like. The memory 202 is, for example, a Dynamic Random Access Memory (DRAM), a Static Random Access Memory (SRAM), a Read Only Memory (ROM), or the like. The image processing unit 203 processes data in a frame buffer which is obtained from the camera 208 for each predetermined frame period in collaboration with the CPU 201. The image processing unit 203 includes, for example, a GPU and an image memory serving as the frame buffer. The external memory 204 is a non-volatile memory and is, for example, a Solid State Drive (SSD), a hard disk drive, or the like.

For example, the control unit 20 acquires detection signals from sensors of units of the vehicle 2 via the interface IF1. The control unit 20 computes a latitude and a longitude which indicate a position on the globe on the basis of a detection signal from the GPS reception unit 216. The control unit 20 acquires map data from a map information database which is stored in the external memory 204, collates the computed latitude and longitude with positions on the map data, and determines a current place. The control unit 20 acquires a route from the current place to a destination on the map data. The control unit 20 senses an obstacle in the surroundings of the vehicle 2 on the basis of signals from the obstacle sensor 209, the camera 208, and the like, determines the traveling direction so as to avoid the obstacle, and controls the steering angle.

The control unit 20 processes an image which is acquired from the camera 208 on a per-frame-data basis in collaboration with the image processing unit 203, senses, for example, a change based on a difference in the image, and recognizes an obstacle. Note that the control unit 20 may transmit frame data of the image from the camera 208 to the center server 1 on the network via the communicator 205. The control unit 20 may cause the center server 1 to take charge of analysis of the frame data of the image.

The mailbox collection/placement mechanism 217 is a mechanism which pertains collecting the mailbox 3 that is placed at a predetermined position and placing the mailbox 3 at a predetermined position. Details of the mailbox collection/placement mechanism 217 will be described later. The mailbox collection/placement mechanism 217 is an example of a collection and placement mechanism.

Although the interface IF1 is given as an example in FIG. 2, transfer of signals between the control unit 20 and a control object is not limited to the interface IF1. That is, the control unit 20 may include a plurality of signal transfer routes other than the interface IF1. In FIG. 2, the control unit 20 includes a single CPU 201. Note a CPU is not limited to a single processor and that the control unit 20 may use a multiprocessor architecture. Alternatively, a single CPU which is connected by a single socket may use a multicore architecture. At least a part of processes of the above-described units may be performed by a processor other than a CPU, such as a dedicated processor (e.g., a Digital Signal Processor (DSP) or a Graphics Processing Unit (GPU)). At least a part of the processes of the above-described units may be pertained by an integrated circuit (IC) or any other digital circuit. At least some of the above-described units may include an analog circuit.

The vehicle 2 may include a mechanism which allows a user to directly input an instruction to the vehicle 2. The mechanism is, for example, a display with a touch panel or a microphone for voice input.

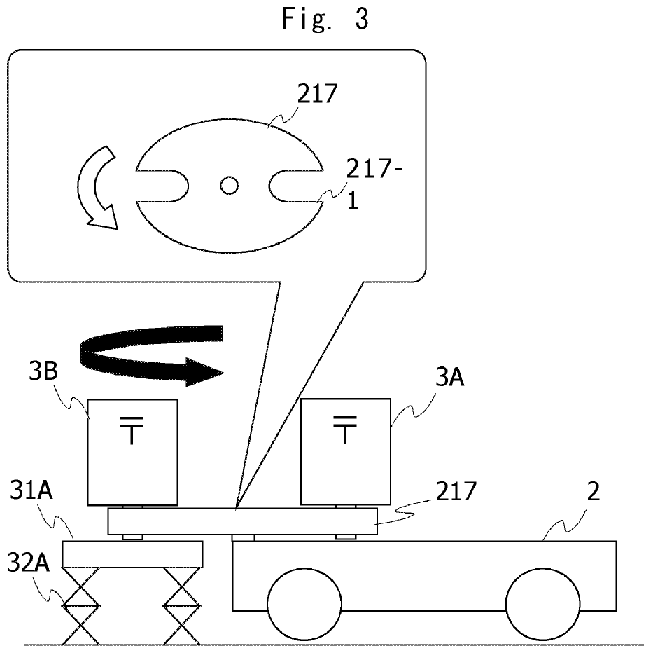

FIG. 3 is a diagram illustrating an example of a method for collecting and placing the mailbox 3 by the vehicle 2. FIG. 3 assumes, as the mailbox 3, a mailbox including a housing with a postal matter slot and a columnar leg which supports the housing.

In FIG. 3, the mailbox collection/placement mechanism 217 is provided on a top surface of the vehicle 2. FIG. 3 illustrates an example where the mailbox collection/placement mechanism 217 places or collects the mailbox 3 by rotating while holding the mailbox 3.

Concretely, the mailbox collection/placement mechanism 217 includes two mailbox holders 217-1. The two mailbox holders 217-1 are, for example, provided so as to face each other across a center of the mailbox collection/placement mechanism 217. In the example illustrated in FIG. 3, the mailbox collection/placement mechanism 217 is disk-shaped. The mailbox holder 217-1 includes a concave shape which allows the leg of the mailbox 3 to be inserted in a horizontal direction. The mailbox holder 217-1 is an example of a holder.

The mailbox collection/placement mechanism 217 is, for example, installed such that the center is closer to one side of the vehicle 2, almost a half is on the vehicle 2, and such that almost the other half protrudes outward from the vehicle 2. The mailbox collection/placement mechanism 217 can rotate about a center portion. The mailbox collection/placement mechanism 217 is installed so as to be movable within a predetermined range on the vehicle 2. Rotation and movement of the mailbox collection/placement mechanism 217 are controlled by, for example, the control unit 20.

The mailbox collection/placement mechanism 217 can move the mailbox 3 from on the vehicle 2 to outside the vehicle 2 or from outside the vehicle 2 onto the vehicle 2 by rotating while holding the mailbox 3 with the leg of the mailbox 3 inserted in the mailbox holder 217-1.

On the vehicle 2, the mailbox 3A is, for example, loaded on a pedestal which is movable within a predetermined range on the vehicle 2. The mailbox collection/placement mechanism 217 is installed so as to be movable within the predetermined range on the vehicle 2. To insert the leg of the mailbox 3 into the mailbox holder 217-1, the pedestal for the mailbox 3A and the mailbox collection/placement mechanism 217 move on the vehicle 2 so as to include an appropriate position relationship with each other. Movement of the pedestal for the mailbox 3A and movement of the mailbox collection/placement mechanism 217 on the vehicle 2 are controlled by, for example, the control unit 20.

For example, the mailbox collection/placement mechanism 217 fits inside a space on the vehicle 2 in its entirety in normal times and moves closer to one side on the vehicle 2 at the time of mailbox collection or placement such that almost a half protrudes outward from the vehicle 2. The pedestal for the mailbox 3A on the vehicle 2 moves in accordance with a position of the mailbox collection/placement mechanism 217 such that the leg of the mailbox 3A is inserted in the mailbox holder 217-1. This allows the mailbox holder 217-1 to hold the mailbox 3A on the vehicle 2 and move the mailbox 3A.

For example, a pedestal 31A and a jack 32A which lifts the pedestal are installed at a mailbox placement site, and the mailbox 3B is placed on the pedestal 31A. The pedestal 31A is lifted to the same height as the top surface of the vehicle 2 by the jack 32A, which allows the mailbox 3B to be inserted into the mailbox holder 217-1 of the mailbox collection/placement mechanism 217. The mailbox collection/placement mechanism 217 then rotates, thereby allowing movement of the mailbox 3B from outside the vehicle 2 onto the vehicle 2 and collection of the mailbox 3B into the vehicle 2. Note that the same processing may be performed to load the empty mailbox 3 onto the vehicle 2.

If the pedestal 31A is lifted to the same height as the top surface of the vehicle 2 by the jack 32A, and the mailbox 3A held by the mailbox holder 217-1 is moved from on the vehicle 2 to outside the vehicle 2, the mailbox 3A can be loaded on the pedestal 31A. After that, the jack 32A contracts, which causes the mailbox 3A to be placed at a predetermined position.

Note that each of the pedestal 31A and the jack 32A is provided with a control unit which includes a processor, a memory, and a communicator and that the height of the pedestal 31A is controlled by, for example, the control unit communicating with the control unit 20 of the vehicle 2. Note that although the two mailbox holders 217-1 are provided in FIG. 3, one or three or more may be provided.

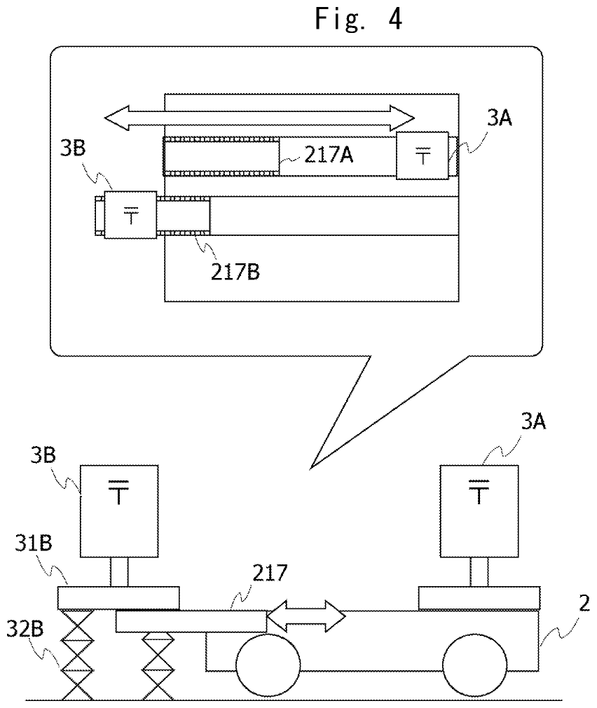

FIG. 4 is a diagram illustrating an example of the method for collecting and placing the mailbox 3 by the vehicle 2. In FIG. 4, the mailbox collection/placement mechanism 217 is provided on the top surface of the vehicle 2. In FIG. 4, the mailbox collection/placement mechanism 217 is a plate which slides on the vehicle 2, and the plate places or collects the mailbox 3 by protruding from the vehicle 2. FIG. 4 also illustrates an external view of the vehicle 2 as seen from above.

Concretely, two mailbox collection/placement mechanisms 217 are, for example, provided on the vehicle 2. Each mailbox collection/placement mechanism 217 can move on rails which are provided on the vehicle 2. The mailbox collection/placement mechanism 217 can move on the rails until one end protrudes from the vehicle 2 by a predetermined length. The mailbox collection/placement mechanism 217 includes a conveyor belt, and working of the conveyor belt allows the mailbox 3 to move on the mailbox collection/placement mechanism 217. Movement of the mailbox collection/placement mechanism 217 on the vehicle 2 and working of the conveyor belt of the mailbox collection/placement mechanism 217 are controlled by, for example, the control unit 20.

In the example illustrated in FIG. 4, the mailbox 3 includes a pedestal 31B and a jack 32B. The jack 32B can be housed in the pedestal 31B. The pedestal 31B is lifted by the jack 32B, and the mailbox collection/placement mechanism 217 gets under the pedestal 31B, which allows the mailbox 3 to be loaded on the mailbox collection/placement mechanism 217.

For example, when the mailbox 3B that is placed at a predetermined position is to be collected, the jack 32B lifts the pedestal 31B to the same height as the top surface of the vehicle 2, which allows a portion of a mailbox collection/placement mechanism 217B which protrudes from the vehicle 2 to get under the pedestal 31B. When the mailbox 3B is loaded on the mailbox collection/placement mechanism 217B, the mailbox collection/placement mechanism 217B can collect the mailbox 3B into the vehicle 2 by sliding on the vehicle 2 so as to fit inside the space on the vehicle 2. Note that the same processing may be performed to load the empty mailbox 3 onto the vehicle 2.

For example, when the mailbox 3A from the vehicle 2 is to be placed at the predetermined position, the jack 32B lifts the pedestal 31B to a predetermined height on the vehicle 2, which allows a mailbox collection/placement mechanism 217A to get under the pedestal 31B. When the mailbox 3A is loaded on the mailbox collection/placement mechanism 217A, a conveyor belt on the mailbox collection/placement mechanism 217A starts working and can move the mailbox 3A to a protruding portion outside the vehicle 2 of the mailbox collection/placement mechanism 217A. The mailbox collection/placement mechanism 217A then protrudes outward from the vehicle 2 by a predetermined length, the jack 32B expands to the ground at the position to support the mailbox 3A, and the mailbox collection/placement mechanism 217A slides on the vehicle 2 so as to fit inside the vehicle 2. After that, the jack 32B contracts, which causes the mailbox 3A to be placed at the predetermined position.

Note that the mailbox 3 in FIG. 4 is provided with a control unit that controls the pedestal 31B and the jack 32B. The control unit includes, for example, a processor, a memory, and a communicator. For example, the control unit controls expansion and contraction of the jack 32B by communicating with the control unit 20 of the vehicle 2, thereby controlling the height of the pedestal 31B. Note that although two mailbox collection/placement mechanisms 217 are provided on the vehicle 2 in FIG. 4, one or three or more may be provided.

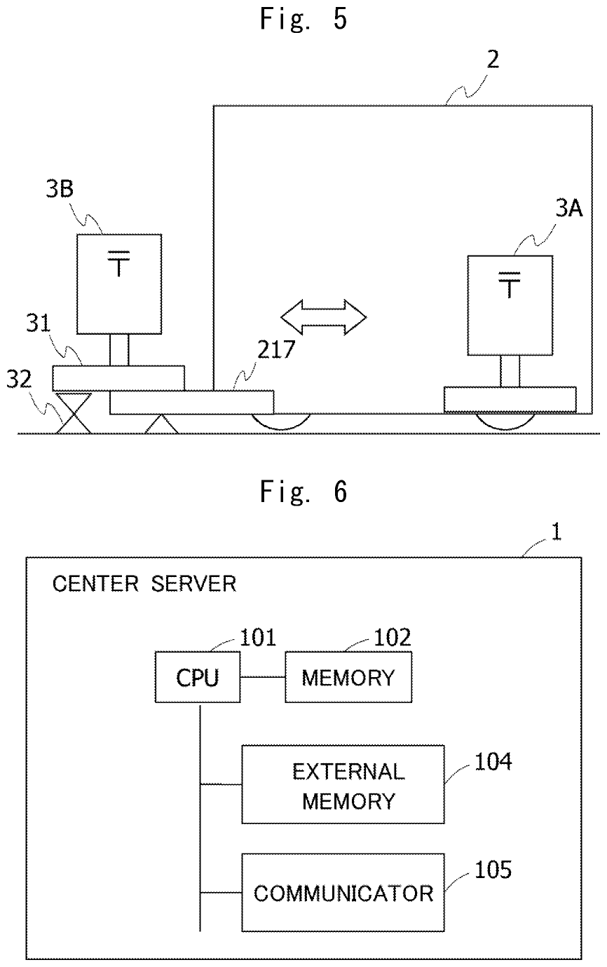

FIG. 5 is a diagram illustrating an example of the method for collecting and placing the mailbox 3 by the vehicle 2. In FIG. 5, the mailbox collection/placement mechanism 217 is provided inside the vehicle 2. The mailbox collection/placement mechanism 217 illustrated in FIG. 5 is the same as that described with reference to FIG. 4. Note that the mailbox collection/placement mechanism 217 illustrated in FIG. 3 may be provided inside the vehicle 2 instead of the mailbox collection/placement mechanism 217 illustrated in FIG. 5.

A method for mailbox collection and placement to be adopted by the vehicle 2 may be any one of the methods illustrated in FIGS. 3 to 5. Alternatively, any other existing method may be adopted.

FIG. 6 is a diagram illustrating an example of a hardware configuration of the center server 1. The center server 1 includes a CPU 101, a memory 102, an external memory 104, and a communicator 105. Configurations and actions of the CPU 101, the memory 102, and the external memory 104 are the same as the CPU 201, the memory 202, and the external memory 204 in FIG. 2.

The communicator 105 connects to the public telecommunication network through, for example, a LAN and communicates with the various types of servers on the network, the vehicle 2, and the like through the public telecommunication network, such as the Internet. Note that the hardware configuration of the center server 1 is not limited to the one illustrated in FIG. 6 and can be appropriately added or replaced in accordance with the embodiment.

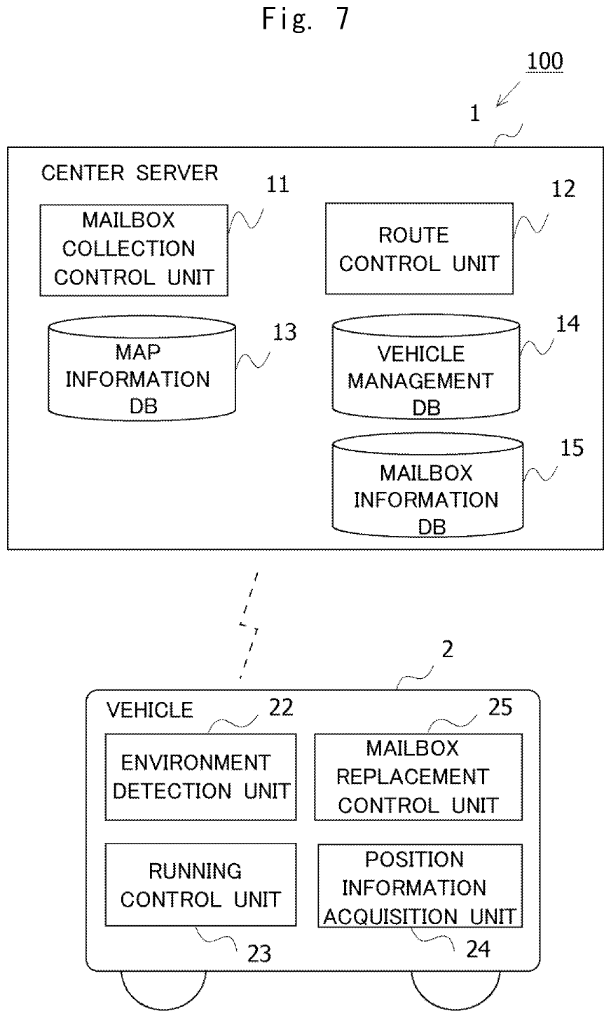

FIG. 7 is a diagram illustrating an example of functional configurations of the center server 1 and the vehicle 2 according to the first embodiment. The center server 1 works as units illustrated in FIG. 7 in accordance with a computer program on the memory 102. That is, the center server 1 includes, as functional constituent elements, a mailbox collection control unit 11, a route control unit 12, a map information database (DB) 13, a vehicle management DB 14, and a mailbox information DB 15.

The mailbox collection control unit 11 performs a process of controlling mailbox collection and placement by the vehicle 2. Concretely, the mailbox collection control unit 11 monitors a remaining time period before an estimated time of pickup for each of mailbox placement sites. When the remaining time period before the estimated time of pickup is less than a threshold, the process of controlling collection and placement of the mailbox 3 is started. The threshold for the remaining time period before the estimated time of pickup that serves as a criterion for starting the process of controlling mailbox collection and placement, is, for example, a value of (a time period required to arrive at a target mailbox placement site)+a. Note that the threshold is not limited to this and may be a fixed value regardless of mailbox placement site.

As the process of controlling mailbox collection and placement, the mailbox collection control unit 11 first performs, for example, selecting the mailbox 3A that is to be placed at a target mailbox placement site instead of the mailbox 3B from among the empty mailboxes 3 and selecting the vehicle 2 that is to perform mailbox collection and placement.

The mailbox collection control unit 11 then forms an operation plan for the vehicle 2. The operation plan for the vehicle 2 includes, for example, being loaded with the selected mailbox 3A, moving to a target mailbox placement site, collecting the mailbox 3B at the target mailbox placement site, placing the selected mailbox 3A, and moving to a mailbox collection site when the vehicle 2 and the empty mailboxes 3 are located at the same site. The mailbox collection site is, for example, a point of departure of the vehicle 2, the location of the empty mailboxes 3, a third place different from these sites, or the like. A movement route between points is formed by, for example, the route control unit 12. The mailbox collection control unit 11 transmits an operation start instruction and the operation plan to the vehicle 2.

The route control unit 12 forms a route from a designated point of departure to a point of arrival in accordance with an instruction from the mailbox collection control unit 11 and outputs the route to the mailbox collection control unit 11.

The map information DB 13, the vehicle management DB 14, and the mailbox information DB 15 are created in the external memory 104 of the center server 1. The map information DB 13 includes, for example, map information in an area to be managed for the center server 1. The map information DB 13 is, for example, referred to when a route is famed by the route control unit 12.

The vehicle management DB 14 holds information on the vehicle 2. Concretely, the vehicle management DB 14 includes identification information, state-related information, position information, and the like of the vehicle 2 that is to perform collection and placement of the mailbox 3. States of the vehicle 2 include standby, during mailbox collection, and the like. Information on the mailbox 3 is stored in the mailbox information DB 15. Details of information held in the mailbox information DB 15 will be described later.

Any one of the functional constituent elements of the center server 1 or a part of processing by the center server 1 may be implemented by a different computer connected to the network. A series of processes to be executed by the center server 1 can be executed by hardware and can also be executed by software.

The vehicle 2 works as units illustrated in FIG. 7 in accordance with the computer program on the memory. That is, the vehicle 2 includes, for example, an environment detection unit 22, a running control unit 23, a position information acquisition unit 24, and a mailbox replacement control unit 25 as functional constituent elements.

The position information acquisition unit 24, for example, acquires position information of the vehicle 2, which is acquired by the GPS reception unit 216, with a predetermined period and transmits the position information to the center server 1. The position information of the vehicle 2 is, for example, a latitude and a longitude. Alternatively, the position information of the vehicle 2 may be an address. The position information of the vehicle 2 acquired by the position information acquisition unit 24 is also output to, for example, the running control unit 23.

The environment detection unit 22 detects environmental information on the surroundings of the vehicle 2 used for autonomous running on the basis of pieces of data which are acquired by the various types of sensors mounted on the vehicle 2. Objects to be detected by the environment detection unit 22 are, for example, pieces of information, such as the number and the positions of lanes, the number and the positions of vehicles present in the surroundings of the vehicle, the number and the positions of obstacles (e.g., a pedestrian, a bicycle, a structure, and a building) present in the surroundings of the vehicle, the structure of a road, and road signs. Note that objects to be detected are not limited to these. An object to be detected may be anything as long as it is used for autonomous running. For example, when a sensor is a stereo camera, detection of a substance in the surroundings of the vehicle 2 is pertained by image-processing image data obtained through image pickup by the stereo camera. Data on a surrounding environment of the vehicle 2 which is detected by the environment detection unit 22 is output to the running control unit 23.

The running control unit 23 receives an operation start instruction and an operation plan from the center server 1. The running control unit 23 forms a control command for controlling autonomous running of the vehicle on the basis of, for example, the operation plan received from the center server 1, data on the surrounding environment of the vehicle 2 generated by the environment detection unit 22, and position information of the vehicle acquired by the position information acquisition unit 24. For example, the running control unit 23 judges whether there is any obstacle in a movement direction indicated by the operation plan and secures movement safety. If it is judged that there is no obstacle in the movement direction, the running control unit 23 forms a control command so as to cause the vehicle to run a route adapted to the operation plan. The formed control command is transmitted to the driving motor 212. As a method for forming a control command for vehicle autonomous running, a publicly known method can be adopted.

The mailbox replacement control unit 25 controls the mailbox collection/placement mechanism 217 that is associated with mailbox collection and placement. For example, at the time of arrival at a target mailbox placement site, the running control unit 23 gives an instruction for mailbox collection and placement to the mailbox replacement control unit 25 on the basis of an operation plan to collect the mailbox 3B and place the selected mailbox 3A.

The mailbox replacement control unit 25 collects the designated mailbox 3B and newly places the designated empty mailbox 3A, in accordance with, for example, the mailbox collection/placement mechanisms 217 and the mailbox collection and placement methods illustrated in FIGS. 3 to 5.

Any one of the functional constituent elements of the vehicle 2 or a part of processing by the vehicle 2 may be implemented by a different computer connected to the network. A series of processes to be executed by the vehicle 2 can be executed by hardware and can also be executed by software. Note that the control unit 20 of the vehicle 2 that is loaded with the mailbox 3A, moves to a placement site of the mailbox 3B, collects the mailbox 3B, and places the mailbox 3A in accordance with an operation plan from the center server 1 is an example of a controller.

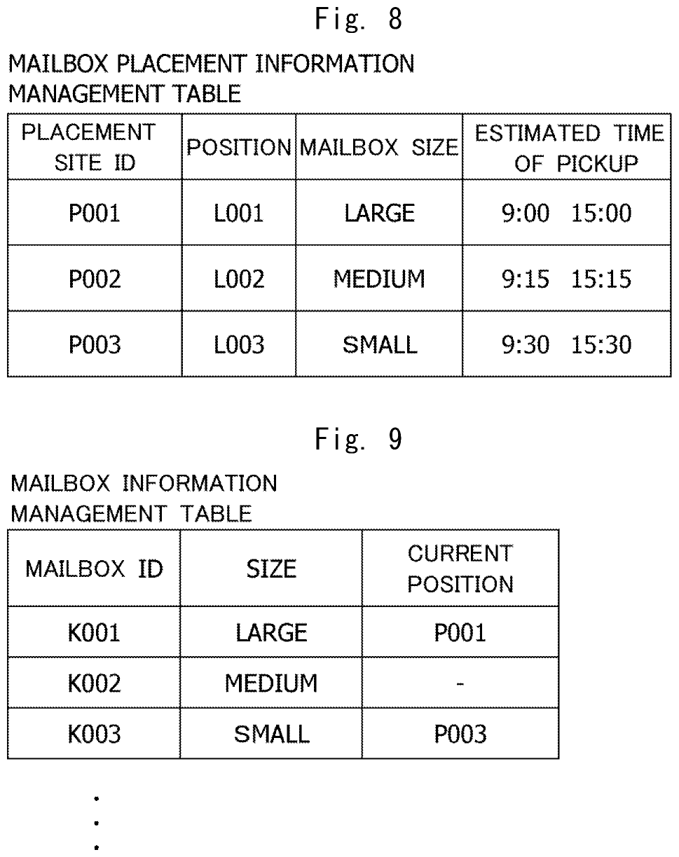

FIG. 8 is an example of a mailbox placement information management table. The mailbox placement information management table is one of tables which are held in the mailbox information DB 15. The mailbox placement information management table holds information on each mailbox placement site.

A placement site ID field, a position field, a mailbox size field, and an estimated-time-of-pickup field are included in the mailbox placement information management table illustrated in FIG. 8. Identification information of a mailbox placement site is contained in a placement site ID field. Position information of the placement site for the mailbox 3 contained in the placement site ID field is contained in a position field. The position information of the mailbox placement site may be, for example, a latitude and a longitude or an address.

Information indicating the size of the mailbox 3 to be placed at the mailbox placement site is contained in a mailbox size field. The expected numbers of posted matters differ according to mailbox placement site. For this reason, a mailbox size appropriate to the expected number of posted matters is set in advance for each mailbox placement site. The example illustrated in FIG. 8 assumes a case where there are available three mailbox sizes. In a mailbox size field in the example illustrated in FIG. 8, any one of large, medium, and small in descending order of size is stored.

Information on an estimated time of posted matter pickup is stored in an estimated-time-of-pickup field. If there are a plurality of pickups per day, information on an estimated time of pickup of each pickup is stored. If weekdays and Saturdays, Sundays, and holidays differ in estimated time of pickup, respective estimated times of pickup are stored.

Note that pieces of information to be stored in the mailbox placement information management table are not limited to those in the example illustrated in FIG. 8. The mailbox placement information management table is, for example, used to judge, for each placed mailbox 3, when to execute the collection and placement process.

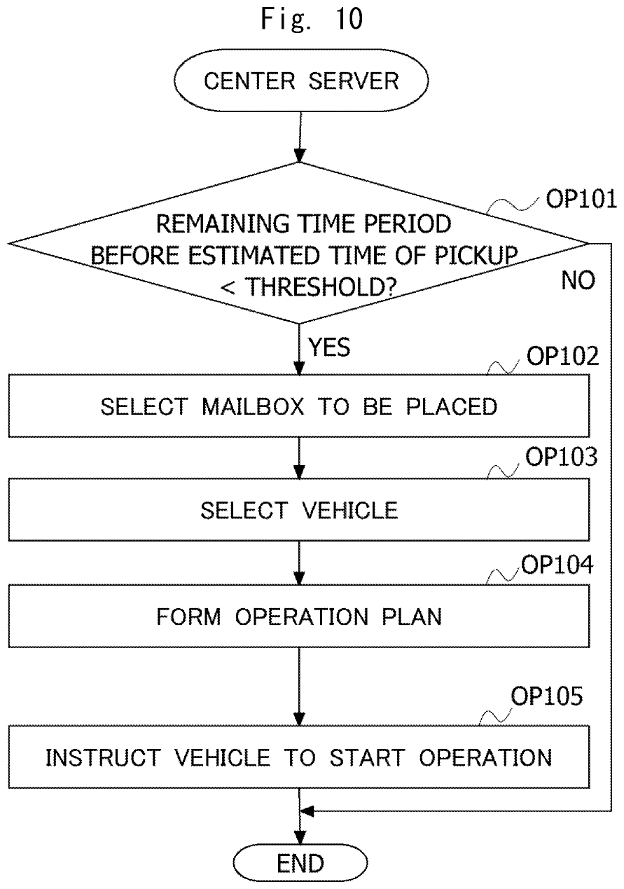

FIG. 9 is an example of a mailbox information management table. The mailbox information management table is one of tables which are held in the mailbox information DB 15. For example, information on each mailbox 3 itself is stored in the mailbox information management table.

A mailbox ID field, a size field, and a current position field are included in the mailbox information management table illustrated in FIG. 9. Identification information of the mailbox 3 is stored in a mailbox ID field. Information indicating the size of the mailbox 3 is stored in a size field.

Identification information of a placement site where the mailbox 3 is currently placed is contained in a current position field. If the mailbox 3 is not placed at any placement site and is retained in a center, the current position field is empty or identification information of the center is contained.

The mailbox information management table illustrated in FIG. 9 is illustrative only, and pieces of information held in the mailbox information management table are not limited to those in the example illustrated in FIG. 9. The mailbox information management table is, for example, referred to when the mailbox 3 to be newly placed instead of the placed mailbox 3 is selected.

<Flow of Process>

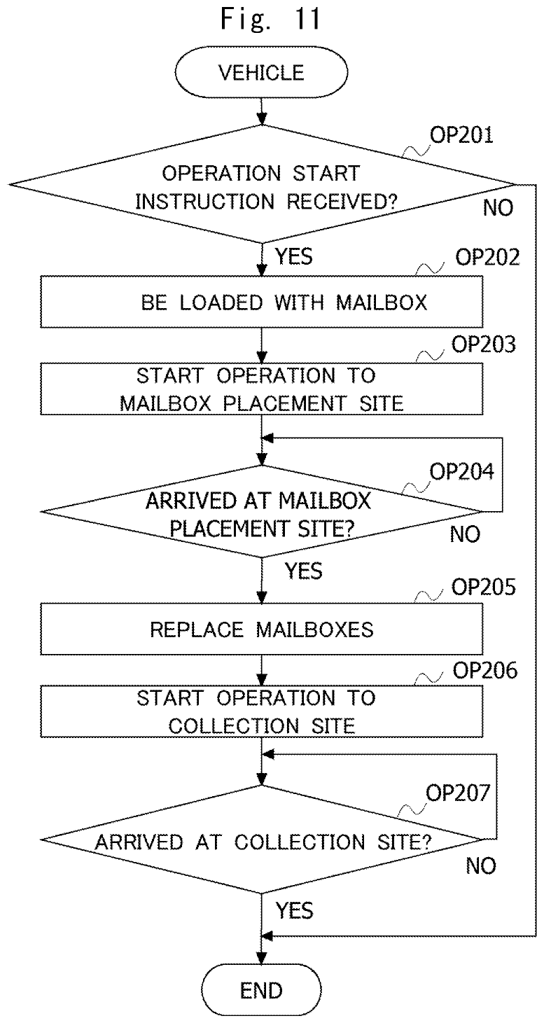

FIG. 10 is an example of the process, by the center server 1 according to the first embodiment, of controlling mailbox collection and placement by the vehicle 2. The process illustrated in FIG. 10 is repeatedly executed with a predetermined period if, for example, the center server 1 is at work or a remaining time period before an estimated time of pickup is less than a predetermined time period. Although the agent of the process illustrated in FIG. 10 is the CPU 101 of the center server 1, a description will be given with a functional constituent element set as the agent for the sake of convenience. The process illustrated in FIG. 10 is, for example, executed for each mailbox placement site.

In OP101, the mailbox collection control unit 11 judges, for a target mailbox placement site, whether a remaining time period before an estimated time of pickup is less than a threshold. If the remaining time period before the estimated time of pickup is less than the threshold (YES in OP101), the process advances to OP102. If the remaining time period before the estimated time of pickup is not less than the threshold (NO in OP101), the process illustrated in FIG. 10 ends.

In OP102, the mailbox collection control unit 11 selects the empty mailbox 3A to be newly placed at the target mailbox placement site. The mailbox collection control unit 11, for example, selects the mailbox 3A that corresponds to a size set in the mailbox placement information management table and is currently empty while referring to the mailbox information management table.

In OP103, the mailbox collection control unit 11 selects the vehicle 2 that is to collect the mailbox 3B at the target mailbox placement site and newly place the mailbox 3A. For example, the mailbox collection control unit 11 refers to the vehicle management DB 14 and selects, from among the vehicles 2 on standby, the vehicle 2 that is to collect the mailbox 3B at the target mailbox placement site and newly place the mailbox 3A.

In OP104, the mailbox collection control unit 11 forms an operation plan. Being loaded with the mailbox 3A selected in OP102, moving to the target mailbox placement site, collecting the mailbox 3B placed at the target mailbox placement site, placing the mailbox 3A selected in OP102, and moving the collected mailbox 3B to a collection site are included in the operation plan. Note that position information of the target mailbox placement site, identification information of the mailbox 3B placed at the target mailbox placement site, and identification information of the mailbox 3A selected in OP102 are also included in the operation plan.

In OP105, the mailbox collection control unit 11 transmits an operation start instruction and the operation plan formed in OP104 to the vehicle 2 selected in OP103. After that, the process illustrated in FIG. 10 ends.

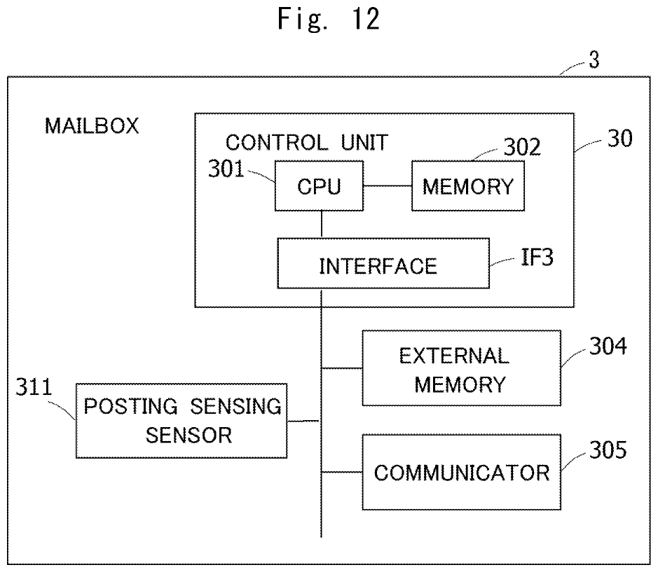

FIG. 11 is an example of a flowchart of an operation process associated with mailbox collection and placement by the vehicle 2. The process illustrated in FIG. 11 is repeatedly executed while the control unit 20 of the vehicle 2 is at work. Although the agent of the process illustrated in FIG. 11 is the control unit 20, a description will be given with functional constituent elements set as the agent for the sake of convenience.

In OP201, the running control unit 23 judges whether an operation start instruction is received from the center server 1. If an operation start instruction is received from the center server 1 (YES in OP201), the process advances to OP202. If an operation start instruction is not received from the center server 1 (NO in OP201), the process illustrated in FIG. 11 ends. An operation plan is received together with the operation start instruction.

In OP202, the running control unit 23 is loaded with the mailbox 3A designated in the operation plan. If the vehicle 2 and the mailbox 3A are different in location, the running control unit 23 moves to the location of the designated mailbox 3A and is loaded with the mailbox 3A.

In OP203, the running control unit 23 starts operation to a mailbox placement site designated in the operation plan. In OP204, the running control unit 23 judges whether the vehicle 2 has arrived at the designated mailbox placement site. If the vehicle 2 has arrived at the designated mailbox placement site (YES in OP204), the process advances to OP205. If the vehicle 2 has not arrived at the designated mailbox placement site (NO in OP204), the process in OP204 is repeated until the vehicle 2 arrives at the designated mailbox placement site.

In OP205, the running control unit 23 instructs the mailbox replacement control unit 25 to perform mailbox collection and placement, and the mailbox replacement control unit 25 controls the mailbox collection/placement mechanism 217 to collect the placed mailbox 3B and newly place the loaded mailbox 3A.

In OP206, the running control unit 23 starts operation to a collection site. In OP207, the running control unit 23 judges whether the vehicle 2 has arrived at the mailbox collection site. If the vehicle 2 has arrived at the mailbox collection site (YES in OP207), the process illustrated in FIG. 11 ends. If the vehicle 2 has not arrived at the mailbox collection site (NO in OP207), the process in OP207 is repeated until the vehicle 2 arrives at the mailbox collection site.

### Action and Effect of First Embodiment

In the first embodiment, collection of a mailbox itself is performed by the vehicle 2 instead of collection of a posted matter in the mailbox. The vehicle 2 is provided with the mailbox collection/placement mechanism 217, and the mailbox collection/placement mechanism 217 collects the mailbox 3B containing posted matters and places the empty mailbox 3A instead. This allows reduction in a human load caused when a staff member opens a mailbox and collects posted matters, for collection of posted matters in a mailbox. If the vehicle 2 is an automated-driving vehicle, a human load can be further reduced.

### Second Embodiment

In the first embodiment, the mailbox 3 is collected at an estimated time of pickup regardless of the presence or absence of posted matters in the mailbox 3. Instead, in a second embodiment, a mailbox 3 is collected at an estimated time of pickup only when the mailbox 3 contains any posted matter. Note that the same description as the first embodiment will be omitted in the second embodiment.

FIG. 12 is an example of a hardware configuration of the mailbox 3 according to the second embodiment. In the second embodiment, the mailbox 3 includes a sensor which senses a posted matter, and transmits a request for pickup of a posted matter to a center server 1 when the mailbox 3 senses posting of the posted matter. The mailbox 3 includes, as hardware constituent elements, a control unit 30, an external memory 304, a communicator 305, and a posting sensing sensor 311. The control unit 30 includes a CPU 301, a memory 302, and an interface IF3. Configurations and actions of the CPU 301, the memory 302, and the external memory 304 are the same as the CPU 201, the memory 202, and the external memory 204 in FIG. 2.

The communicator 305 is a communicator for connecting to, for example, a Wi-Fi (registered trademark) access point or a cell tower and communicating with various types of servers and the like on a network through a public telecommunication network connected to the Wi-Fi (registered trademark) access point or the cell tower. The communicator 305 performs wireless communication using wireless signals and a wireless communication method compliant with a predetermined wireless communication standard.

The posting sensing sensor 311 is a sensor which senses the presence or absence of a posted matter. The posting sensing sensor 311 may be, for example, a weight sensor and sense the presence of a posted matter on the basis of a change in a weight in the mailbox 3. Alternatively, the posting sensing sensor 311 may be, for example, a sensor which detects opening and closing of a flap at a mail slot. Note that the hardware configuration of the mailbox 3 is not limited to the one illustrated in FIG. 12.

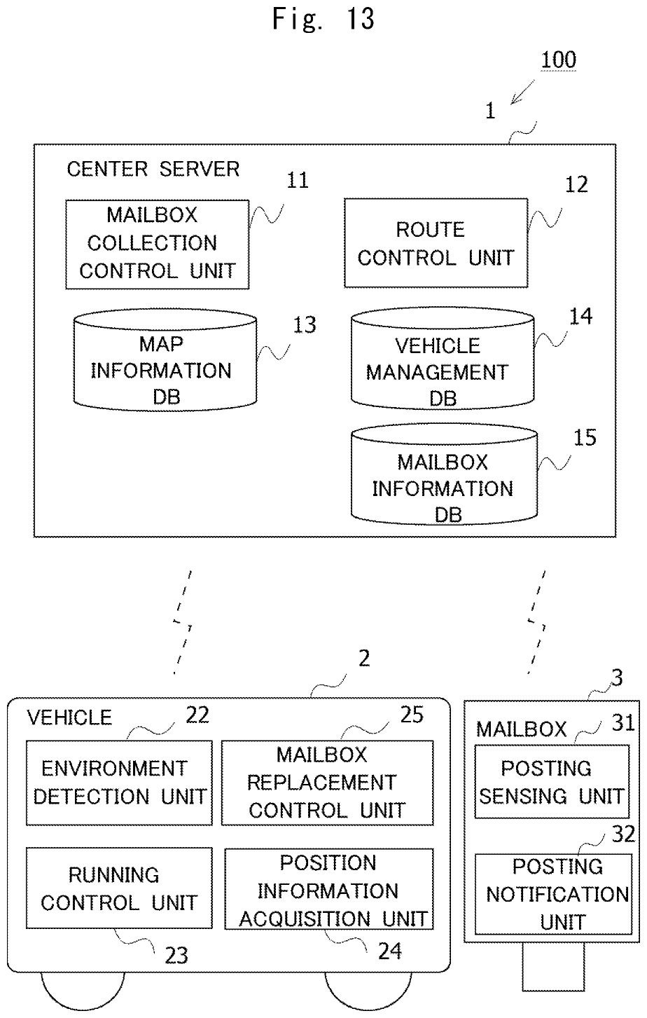

FIG. 13 is a diagram illustrating examples of functional configurations of the center server 1, a vehicle 2, and the mailbox 3 according to the second embodiment. The functional configurations of the center server 1 and the vehicle 2 are the same as those in FIG. 7. The mailbox 3 works as units illustrated in FIG. 13 in accordance with a computer program on the memory 302. That is, the mailbox 3 includes, for example, a posting sensing unit 31 and a posting notification unit 32 as functional constituent elements.

The posting sensing unit 31 senses occurrence of posting in the mailbox 3 on the basis of a detection value from the posting sensing sensor 311. The posting sensing unit 31 notifies the posting notification unit 32 of the occurrence of posting. Upon receipt of the notification of the occurrence of posting from the posting sensing unit 31, the posting notification unit 32 transmits a request for posted matter pickup to the center server 1 through the communicator 305. Identification information of the mailbox 3 is transmitted together with the request for posted matter pickup.

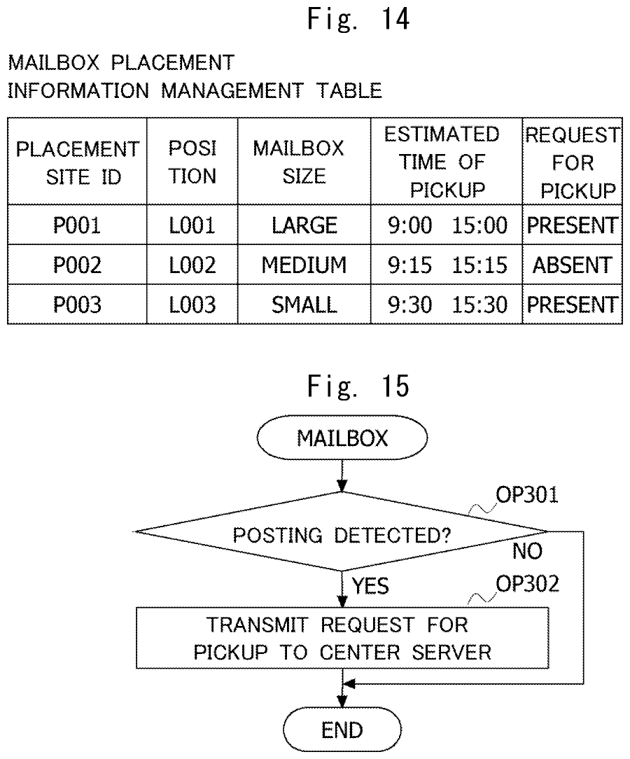

FIG. 14 is an example of a mailbox placement information management table according to the second embodiment. In the second embodiment, a request-for-pickup field is included in addition to a placement site ID field, a position field, a mailbox size field, and an estimated-time-of-pickup field in the mailbox placement information management table. The placement site ID field, the position field, the mailbox size field, and the estimated-time-of-pickup field are the same as in FIG. 8.

Information indicating whether a request for posted matter pickup is received from the mailbox 3 that is placed at a mailbox placement site in question is contained in a request-for-pickup field. For example, when a mailbox collection control unit 11 of the center server 1 receives a request for posted matter pickup from the mailbox 3, the mailbox collection control unit 11 identifies a placement site of the mailbox 3 from identification information of the mailbox 3 and updates a request-for-pickup field for the mailbox placement site in the mailbox placement information management table to “PRESENT.” For example, when collection and placement of the mailboxes 3 are performed for the mailbox placement site, the request-for-pickup field is updated to “ABSENT.”

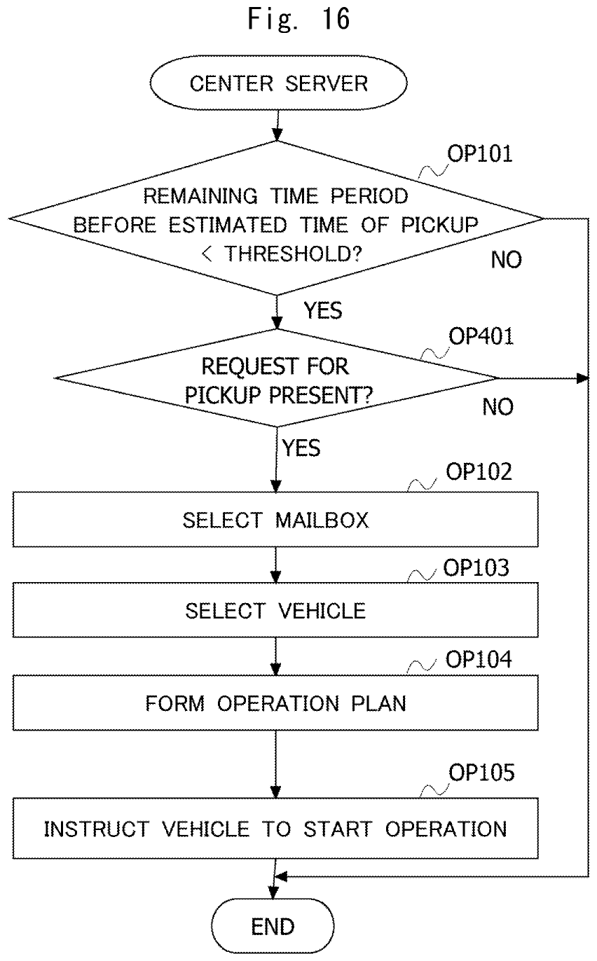

FIG. 15 is an example of a flowchart of a process by a mailbox 3B. The example illustrated in FIG. 15 is repeatedly executed while the control unit 30 of the mailbox 3 is at work. Note that the control unit 30 of the mailbox 3, for example, may be activated when the mailbox 3 is loaded on the vehicle 2 and may be stopped when the mailbox 3 is collected into a collection site. Although the agent of the process illustrated in FIG. 15 is the CPU 301 of the mailbox 3, a description will be given with a functional constituent element set as the agent for the sake of convenience.

In OP301, the posting notification unit 32 judges whether notification of occurrence of posting is received from the posting sensing unit 31. If notification of occurrence of posting is received from the posting sensing unit 31 (YES in OP301), the process advances to OP302. If notification of occurrence of posting is not received from the posting sensing unit 31 (NO in OP301), the process illustrated in FIG. 15 ends.

In OP302, the posting notification unit 32 transmits a request for posted matter pickup to the center server 1. After that, the process illustrated in FIG. 15 ends.

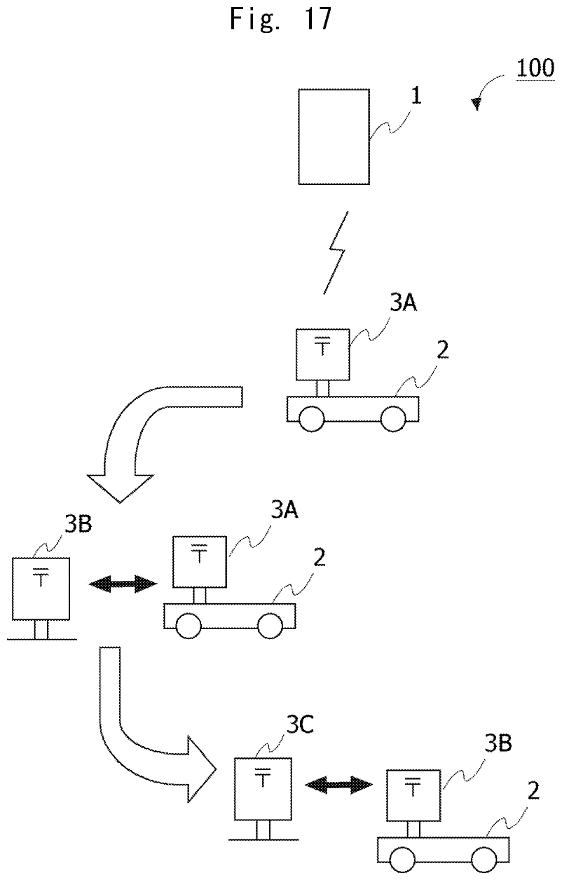

FIG. 16 is an example of a process, by the center server 1 according to the second embodiment, of controlling mailbox collection and placement by the vehicle 2. The same processes as those in FIG. 10 are denoted by the same reference numerals in FIG. 16.

When a remaining time period before an estimated time of pickup is less than a threshold (YES in OP101), the mailbox collection control unit 11 judges whether a request for posted matter pickup is received from the mailbox 3B that is placed at a target mailbox placement site. The judgment is made by, for example, referring to the mailbox placement information management table. If a request for posted matter pickup is received from the mailbox 3B placed at the target mailbox placement site (YES in OP401), the process advances to OP102 to perform mailbox collection and placement at the target mailbox placement site. If a request for posted matter pickup is not received from the mailbox 3B placed at the target mailbox placement site (NO in OP401), the process illustrated in FIG. 16 ends.

That is, in the second embodiment, the mailbox 3 that contains no posted matter at an estimated time of pickup is not collected and remains placed at a placement site. The mailbox 3 containing no posted matter need not be collected. According to the second embodiment, a processing load on the vehicle 2 required for posted matter collection can be reduced.

### Third Embodiment

A third embodiment assumes that one vehicle 2 collects a plurality of mailboxes 3 in one round of operation. For example, an estimated time of mailbox pickup is often set on the assumption that a plurality of mailboxes 3 within a predetermined range which fall into the same area are visited in one round of operation. That is, the order in which mailbox placement sites within a predetermined area are visited may be fixed.

For example, the vehicle 2 may include a posted matter collection mechanism 218 (FIG. 2) which includes a function of collecting a posted matter in the mailbox 3. The posted matter collection mechanism 218, for example, includes a function of unlocking the mailbox 3 and replacing a bag containing posted matters with an empty bag. If the mailbox 3 does not include a bag to contain posted matters and includes, for example, an opening unit at a bottom surface, the posted matter collection mechanism 218 may be a mechanism which opens the opening unit at the bottom surface of the mailbox 3 and takes out posted matters in the mailbox 3.

FIG. 17 is a diagram illustrating an example of a system configuration of a mailbox collection system 100 according to the third embodiment. For example, when the vehicle 2 performs operation that collects posted matters in the order of the mailbox 3B and the mailbox 3C in FIG. 17, a center server 1 forms an operation plan as described below. The vehicle 2 is first loaded with one empty mailbox 3A and departs. The vehicle 2 collects the mailbox 3B at a placement site of the mailbox 3B and places the empty mailbox 3A. The vehicle 2 collects posted matters in the collected mailbox 3B and heads toward a placement site of the next mailbox 3C. The vehicle 2 collects the mailbox 3C at the placement site of the mailbox 3C and places the mailbox 3B in an empty state. With this configuration, when the vehicle 2 collects posted matters in the plurality of mailboxes 3A and 3B, empty mailboxes 3 to be mounted in advance can be confined to the one mailbox 3A, and the utilization rate of the mailboxes 3 can be improved.

Note that, when the order in which mailbox placement sites within a predetermined area are visited is not fixed, the center server 1 may determine the visit order and a route for the visit.

### Other Embodiments

The above-described embodiments are merely illustrative, and the present disclosure can be appropriately changed and implemented without departing from the scope thereof.

In the first and second embodiments, when a plurality of mailboxes 3 is collected in one round of operation of the vehicle 2, the center server 1 may form a route by which placement sites of the plurality of mailboxes 3 are visited and include the route and a visit order in an operation plan. Alternatively, the center server 1 selects, for each of a plurality of mailboxes 3 to be collected, the empty mailbox 3 to be newly placed, and causes the vehicle to be loaded with the mailboxes 3 and depart. This allows collection of the plurality of mailboxes 3 in one round of operation of the vehicle 2.

Although a server controls mailbox collection and placement in the first and second embodiments, the vehicle 2 may control mailbox collection and placement instead. For example, mailbox placement sites, for which the vehicle 2 takes charge of controlling mailbox collection and placement, may be assigned in advance, and the vehicle 2 may execute, for example, the process illustrated in FIG. 10 or the processes illustrated in FIGS. 15 and 16 for the assigned mailbox placement sites. In this case, the mailboxes 3 to be used by the vehicle 2 may be assigned in advance, or the mailboxes 3 to be used may be determined after acquiring information on the mailboxes 3 from the center server 1.

The processes and means described in the present disclosure can be freely combined and implemented as long as there is no technical contradiction.

A process described as being performed by one apparatus may be shared and executed by a plurality of apparatuses. Alternatively, a process described as being performed by different apparatuses may be executed by one apparatus. By which hardware configuration (server configuration) functions are implemented in a computer system can be flexibly changed.

The present disclosure can also be implemented by supplying a computer program including the functions described in the above-described embodiment to a computer and reading out and executing the program by one or more processors of the computer. This computer program may be provided to the computer as a non-transitory computer-readable storage medium connectable to a system bus of the computer or may be provided to the computer via a network. Examples of the non-transitory computer-readable storage medium include any type of disk, such as a magnetic disk (e.g., a floppy(R) disk or a hard disk drive (HDD)) or an optical disc (e.g., a CD-ROM, a DVD, or a Blu-ray Disc), a read only memory (ROM), a random access memory (RAM), an EPROM, an EEPROM, a magnetic card, a flash memory, an optical card, and any type of medium suitable for storing electronic instructions.

What is claimed is:

1. A system comprising:
a vehicle including a collection and placement mechanism configured to collect and place a mailbox;
a plurality of mailboxes that is capable of being transported, collected, and placed by the vehicle; and
a controller comprising at least one processor configured to cause the vehicle to execute:
being loaded with a first mailbox containing no posted matter;
moving to a placement site of a second mailbox containing a posted matter in a state of being loaded with the first mailbox; and
collecting the second mailbox and newly placing the first mailbox, at the placement site of the second mailbox, by the collection and placement mechanism, in order to replace the mailboxes.

2. The system according to claim 1, wherein
when a remaining time period before an estimated time of posted matter pickup at the placement site of the second mailbox is less than a predetermined time period, the controller selects the first mailbox from among the plurality of mailboxes and gives an instruction to the vehicle to be loaded with the first mailbox, move to the placement site of the second mailbox, and replace the mailboxes.

3. The system according to claim 1, wherein
each of the plurality of mailboxes includes
a sensor configured to sense posting of a posted matter, and
a communicator configured to transmit a request for pickup of a posted matter when posting of the posted matter is sensed, and
when the request for pickup of the posted matter is received from the second mailbox, the controller gives an instruction to the vehicle to be loaded with the first mailbox, move to the placement site of the second mailbox, and replace the mailboxes.

4. The system according to claim 1, wherein
when a plurality of second mailboxes is installed at a plurality of placement sites, the controller further executes:
selecting ones, which are equal in number to the plurality of second mailboxes, of first mailboxes constituting the first mailbox; and
giving an instruction of a route by which placement sites of the plurality of second mailboxes are visited, to the vehicle.

5. The system according to claim 1, wherein
the vehicle further includes a posted matter collector configured to collect a posted matter contained in a mailbox, and
when a plurality of second mailboxes is installed at a plurality of placement sites, the controller causes the collection and placement mechanism to reuse one of the second mailboxes, from which a posted matter is collected by the posted matter collector, as a new first mailbox and replace another one of the second mailboxes, from which a posted matter is to be collected next, with the new first mailbox.

6. The system according to claim 1, wherein
the collection and placement mechanism of the vehicle includes at least one holder configured to hold a mailbox, and
the holder moves from inside the vehicle to outside the vehicle while holding the first mailbox and moving from outside the vehicle to inside the vehicle while holding the second mailbox to replace the mailboxes.

7. The system according to claim 1, wherein
the collection and placement mechanism of the vehicle includes at least one plate, one end of which protrudes outward from the vehicle when the plate slides, and
the one end of the plate collects the second mailbox by getting under the second mailbox and being loaded with the second mailbox when the one end of the plate protrudes outward from the vehicle, and sliding into the vehicle, and the one end of the plate places the first mailbox by protruding outward from the vehicle in a state of being loaded with the first mailbox, and leaving the first mailbox and sliding into the vehicle.

8. The system according to claim 1, wherein
the second mailbox is installed on a pedestal that includes a jack, and
the jack lifts the second mailbox to a height that allows the second mailbox to be collected by the collection and placement mechanism.

9. The system according to claim 1, wherein
the vehicle is a vehicle capable of autonomous running.

10. The system according to claim 1, wherein
the collection and placement mechanism is provided on a top surface of the vehicle.

11. The system according to claim 1, wherein
the collection and placement mechanism is provided inside the vehicle.

12. A vehicle comprising:
a running mechanism including a plurality of wheels;
a collection and placement mechanism configured to collect and place a mailbox; and
a controller comprising at least one processor configured to execute
causing the collection and placement mechanism to load a first mailbox containing no posted matter,
causing the running mechanism to move to a placement site of a second mailbox containing a posted matter in a state of being loaded with the first mailbox, and
causing the collection and placement mechanism to collect the second mailbox and newly place the first mailbox, at the placement site of the second mailbox.

13. The vehicle according to claim 12, further comprising
a posted matter collector configured to collect a posted matter contained in a mailbox, wherein
when a plurality of second mailboxes is installed at a plurality of placement sites, the controller causes the collection and placement mechanism to reuse one of the second mailboxes, from which a posted matter is collected by the posted matter collector, as a new first mailbox and replace another one of the second mailboxes, from which a posted matter is to be collected next, with the new first mailbox.

14. The vehicle according to claim 12, wherein
the collection and placement mechanism includes at least one holder configured to hold a mailbox, and
the holder moves from inside the vehicle to outside the vehicle while holding the first mailbox and moves from outside the vehicle to inside the vehicle while holding the second mailbox to replace the mailboxes.

15. The vehicle according to claim 12, wherein
the collection and placement mechanism includes at least one plate, one end of which protrudes outward from the vehicle when the plate slides, and
the one end of the plate collects the second mailbox by getting under the second mailbox and being loaded with the second mailbox when the one end of the plate protrudes outward from the vehicle, and sliding into the vehicle, and the one end of the plate places the first mailbox by protruding outward from the vehicle in a state of being loaded with the first mailbox, and leaving the first mailbox and sliding into the vehicle.

16. The vehicle according to claim 12, wherein
the vehicle is a vehicle capable of autonomous running.

17. The vehicle according to claim 12, wherein
the collection and placement mechanism is provided on a top surface of the vehicle.

18. The vehicle according to claim 12, wherein
the collection and placement mechanism is provided inside the vehicle.

19. A method for causing a vehicle including a collection and placement mechanism configured to collect and place a mailbox to execute:
being loaded with a first mailbox containing no posted matter;
moving to a placement site of a second mailbox containing a posted matter in a state of being loaded with the first mailbox; and
collecting the second mailbox and newly placing the first mailbox, at the placement site of the second mailbox, by the collection and placement mechanism, in order to replace the mailboxes.

20. The method according to claim 19, wherein
the second mailbox includes
a sensor configured to sense posting of a posted matter, and
a communicator configured to transmit a request for pickup of a posted matter when posting of the posted matter is sensed, and
when the request for pickup of the posted matter is received from the second mailbox, the vehicle is caused to execute being loaded with the first mailbox, moving to the placement site of the second mailbox, and replacing the mailboxes.
